(19) United States
(12) Patent Application Publication
(10) Pub. No.: US 2007/0174080 A1
(43) Pub. Date: Jul. 26, 2007

(54) Method and apparatus for improved transaction security using a telephone as a security token

(76) Inventor: Christopher Scott Outwater, Santa Barbara, CA (US)

Correspondence Address: Christopher Outwater, 329 San Ysidro Rd, Santa Barbara, CA, 93108, US

(21) Appl. No.: 11/590,604

(22) Filed: Oct. 30, 2006

Related U.S. Application Data
(60) Provisional application No. 60/760,473, filed on Jan. 20, 2006.

(51) Int. Cl. G06Q 99/00

(52) U.S. Cl. 705/1

(57) ABSTRACT

A method and apparatus are disclosed by which customers of an institution, such as a bank, may register one or more of their landline telephone or mobile telephone numbers and associate the telephone numbers with their account and thereafter in conjunction with a remote transaction, use the registered telephone to call into a bank system, or be called by a bank system, for verification, whereby the registered telephone becomes a security token that elevates the security of the transaction.

### CROSS REFERENCE TO RELATED APPLICATIONS

This non-provisional patent application is a continuation-in-part of provisional application “METHOD AND APPARATUS ALLOWING INDIVIDUALS TO ENROLL INTO A KNOWN GROUP, DISPENSE TOKENS, AND RAPIDLY IDENTIFY GROUP MEMBERS”, No. 60/760,473 filed with the USPTO on Jan. 20, 2006.

### FIELD OF THE INVENTION

The present invention relates generally to a system and method for improved security during electronic transactions. More particular, the invention relates to a system and method that associates a phone number and uses this phone number before or during the electronic transaction as one part of a multi-part authentication and identification process before authorizing the transaction.

### STATEMENT REGARDING FEDERALLY SPONSORED RESEARCH OR DEVELOPMENT

Not Applicable

### REFERENCE TO COMPUTER PROGRAM LISTING APPENDICES

Not Applicable

### BACKGROUND OF THE INVENTION

Online and Telephone Banking, common examples of distance transactions, are becoming much more prone to fraudulent activity as the Internet opens up a world of illegal activity to thieves who can operate globally and with impunity inside and outside the borders of the United States and other developed countries. The classic security triangle divides proof of identity into three categories: “Who you are” (provided by biometric such as voice print, fingerprint, face scan, iris scan, etc.), “what you know” (e.g. a username and password, pass-phrase or other secret knowledge), and “what you have” (e.g. a key, token, artifact, tag, card, etc.) In various combinations this triangle has been used to ensure varying levels of access to secure areas and secure transactions.

Online banking transactions currently require only a username and password as login credentials for verification: providing only a “what you know” challenge. Phishing schemes are a frequently seen in email spam and commonly, though not exclusively, associated with the Internet. In a phishing scheme, a criminal attempts to fool customers into revealing the username and password for their online banking accounts, or other accounts of value. Once revealed, the criminal is able to pass the “what you know” challenge posed by the institution, and subsequently has access to the customer's account.

In order to change this, other legs of the security triangle must be brought into play: additional proof of identify, not in the “what you know” category, is needed for these distance transactions.

“Who you are” can be addressed with a biometric reader (e.g., a finger print reader, face recognition camera and software, etc.). However, biometric readers are expensive and difficult to install, may require training to operate, and often give false readings. As such, they are not good candidates for wide, low-cost distribution to millions of customers.

“what you have” can be addressed by providing each customer with a physical security token. However, all commonly available security tokens, for example the Verisign® USB Token or VeriSign® Unified Authentication-Smart Cards, both manufactured by VeriSign, Inc. of Mountain View, Calif., are expensive, require some installation on the customer's part, and represent an additional item that must be carried by a customer wherever he might choose to initiate a distance transaction. As such, these security tokens will encounter some resistance in the marketplace.

In U.S. patent application Ser. No. 11/077,948, Camaisa et al. teach a system for online session security, which in the event that other authentication mechanisms have failed, sends a code as an short message service (SMS) message to a customer's wireless telephone. The customer is then required to transcribe that code into the online session. Unfortunately, SMS messaging is only available on some wireless telephones, and generally not available on landline telephones. Further, the step of transcribing a code is inconvenient and prone to errors in transcription. A simpler mechanism is needed.

### OBJECTS AND SUMMARY OF THE INVENTION

The present invention relates generally to a system and method for improved security during electronic transactions. More particular, the invention relates to a system and method that associates a phone number and uses this phone number before or during the electronic transaction as one part of a multi-part authentication and identification process before authorizing the transaction. The ability to confirm the use of an associated phone number in essence turns that telephone into a security token of the “what you have” category. The key concept to this invention is that almost every person in developed countries with banking systems and Internet connections also owns a telephone (sometimes several), whether a landline, or mobile. This telephone and its associated telephone number can be associated with a customer record, or the customer's account record. As such, with the telephone number in a database and associated directly or otherwise with the customer's profile, the customer's telephone, the ubiquitous telephone, when tied to a bank phone center and caller ID system that is linked to the banks online servers, becomes a security token that is effectively readable by the bank's computer networks.

In the exemplary field of electronic bank transactions, banks and their customers desire secure electronic transactions. Under the prior art, the identity of bank customers was initially presumed from their username and password (in the category of “what you know”), but in the present invention, that identify is further validated by communication through the customer's pre-registered phone number (adding the category of “what you have”).

This system can work in conjunction with various software programs that monitor transactions for suspicious activity, for instance, activity out of character relative to a bank customer's normal activities. That is, the present invention might be called into play only as suspicious transactions are requested, but not before. As an example from the banking industry, online paying of bills to pre-established payees is an activity occurring at least monthly and which represents the only kind of transaction in most online sessions for many customers. As such, as a matter of policy, a bank offering online services may choose to allow paying of bills to pre-established payees without requiring the additional security afforded by the present invention. However, if transactions outside such a policy are requested, or if a transaction out of character for the particular customer (e.g., an unusually large payment to a payee that usually receives relatively small payments), then the present invention can be used to improve confidence that the session in question is in fact being conducted by the customer, or that the transaction in question has explicit approval of the customer.

There are two basic steps to the process of making your existing telephone and its unique number a transaction security token: First, an institution must provide a system that ties an interactive voice response (IVR) system, preferably with telephone caller ID capabilities, to the institution's online servers, in accordance with the present invention. Second, the institution must implement a procedure whereby a customer can register at least one telephone number to be used as a security token.

A telephone can be registered to become this security token through a simple registration process that can be conducted in person with an employee of the institution, but is preferably performed using an ATM. The ATM has the advantage of being faster and easier for most people, and lower cost to the institution. A further security advantage of an ATM is that many also include a photographic record of the customer at the ATM during such transactions.

In the alternative, a phone can be registered using an IVR system, or online. In such cases, registration can proceed after the customer has authenticated once using the challenge/response process employing such classic questions as “mother's maiden name” and “last four digits of you social security number” well known in the art. However, allowing such registrations with strictly “what you know” authentication will ultimately weaken security, and it is preferable to keep the registration of a new telephone as a “what you have” category of security by requiring a “what you have” category of security (i.e., an ATM card, or another, previously registered telephone).

At the end of this process, at least one phone number, and thus its associated telephone, will be tied to the online customer's records. Before the registration process completes, the customer is preferably provided with a phone number to call using the newly registered telephone. This can be a local or toll free number. The result of placing this call is to verify that the telephone provides caller ID information that is not blocked. If it is blocked, it will fall to the institutions servers to call the registered telephone number whenever a session or transaction requires verification.

During the registration process the customer is preferably advised that the addition of caller ID blocking may reduce the convenience of future distance transactions, or that removing caller ID blocking will increase the convenience of future distance transactions.

It is the goal of the present invention to make distance transactions, most typically an online banking session, as safe and secure as possible with the least amount of expense, complication and inconvenience. Customers harbor a growing concern over security of access to their accounts, but still demand transaction speed and convenience.

It is a further goal of the present invention that institutions and their customers electing to make use of this invention are substantially able to do so by utilizing hardware that they all already own and are familiar with, such as the banks' standard secure servers and IVR phone systems, and the customers' computers, web browsers, and telephones, though some re-programming and perhaps reconfiguration of suitable institutional systems will be necessary.

The detailed description will place an emphasis on banking transactions, by way of example. However, this is not intended to represent a limitation, but merely a broadly understood field suitable for an example. In particular, it is a goal of the present invention to be suitable for distance transactions of many sorts, including, but not limited to online credit card transactions (e.g., Amazon.com of Seattle, Wash., airline tickets), online auctions (e.g., eBay.com of San Jose, Calif.), online shopping, etc.

Further, it is a goal of the invention that it can be used in the context of in-store transactions for confirming the validity of a credit card customer, especially for cases when the credit card is being used in a manner that is unusual for the customer. This goal of the invention is particularly pertinent when the telephone in question is a mobile phone.

It is a further goal of the invention to provide improved security, for example, in the passenger transportation system, where the verification of a credit card or other membership-based transaction *** (e.g., the American Automobile Association, of Heathrow, Fla.) can contribute to improving security for taxi drivers, automobile rental companies, and airports.

Yet another goal of the present invention is to further deter fraud which might be otherwise achieved by stealing a registered telephone and using it to conduct a fraudulent transaction, since mobile telephones are increasingly capable of being located whenever they are active, whether through internal global positioning system (GPS) sensing, or merely by triangulation from cellular telephone towers within range. Such fraud is additionally deterred because carrying a device that can be located and tracked by automatic processes significantly increases the criminal's risk of capture.

### BRIEF DESCRIPTION OF THE DRAWINGS

The aspects of the present invention will be apparent upon consideration of the following detailed description taken in conjunction with the accompanying drawings, in which like-referenced characters refer to like parts throughout, and in which:

FIG. 1 is a flowchart of a session employing the present invention;

FIG. 2 is a flowchart of a telephone authentication step using an inbound call from the customer;

FIG. 3 is a flowchart of a telephone authentication step using an outbound call placed to the customer;

FIG. 4 is a database schema representing a customer and account database augmented by the customer telephone as in the present invention;

FIG. 5 is a detailed block diagram of a distance transaction system, including a station for registering a customer's telephone.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

The invention is best illustrated in the context of an online banking system that requires an additional physical (“what you have”) security token in order to enable certain banking transactions, such as unscheduled payments and funds transfer, resetting passwords, etc., that involve increased exposure to fraud and financial loss to the bank and significant inconvenience to the customer.

An ATM or other kiosk-based process is preferably used to enroll a pre-established banking customer into an enhanced, known-customer database that is defined by multiple data points related to the customer, including at least one of the customer's telephone numbers, thus enabling convenient entry of confirmation of transactions during an online or telephone based banking session, using a different channel of communication, namely, a distinct telephone call to that customer's registered telephone.

The bank customer during registration and enrollment elects and agrees to have unique personal information data and records tied to the registered telephone number(s) and this additional account information entered into a secure, central database.

The bank preferably issues to the customer a call-in telephone number so that the customer can call that number from any of his registered telephone number(s) in order to initiate, authenticate, and enable a secure electronic banking session.

Optionally, the enrollee can request supplemental dial-in phone numbers, including those for trusted family members. Such a combination might be used when the primary customer is traveling out of the country and wishes a spouse or trusted person to initiate a session at a preset time if the traveling customer cannot obtain service for a registered mobile phone, or caller ID information is not propagated from the country in which the customer is traveling.

### Definitions:

“Customer” is the unique person tied to a unique number and/or set of personal information and data attached to a valid, bank ATM or credit card and account held by a sponsoring institution (e.g., the bank or credit card company) for its customer.

“ATM” means the global network of automatic teller machines linked to a global network of financial databases.

“ID database” means that secure, remote database that contains the data of each enrollee of the known group, including his/her financial and biometric and personal history.

“Caller ID” means that device and system by which incoming telephone calls can be identified.

“Secure, central database” means a database that is accessed only by authorized entities, including, the sponsoring institution (e.g., the bank), and possibly transportation agencies, government, and law enforcement agencies.

Note that throughout, when the term ‘date’ or ‘time’ is used to specify a point in time (as opposed to an interval), the meaning is intended to include a combined date and time, rather than strictly one or the other.

ATM or kiosk-based enrollment locations are preferably traditional, pre-existing ATM's designated by a bank, or other sponsoring institution, that can be used to register a customer's phone number to an account and customer identification data.

Already a significant number of ATM installations capture a facial image of a customer using built-in surveillance and surrounding security cameras. This significantly improves the security of such registrations, as it provides elements of the “who you are” security leg.

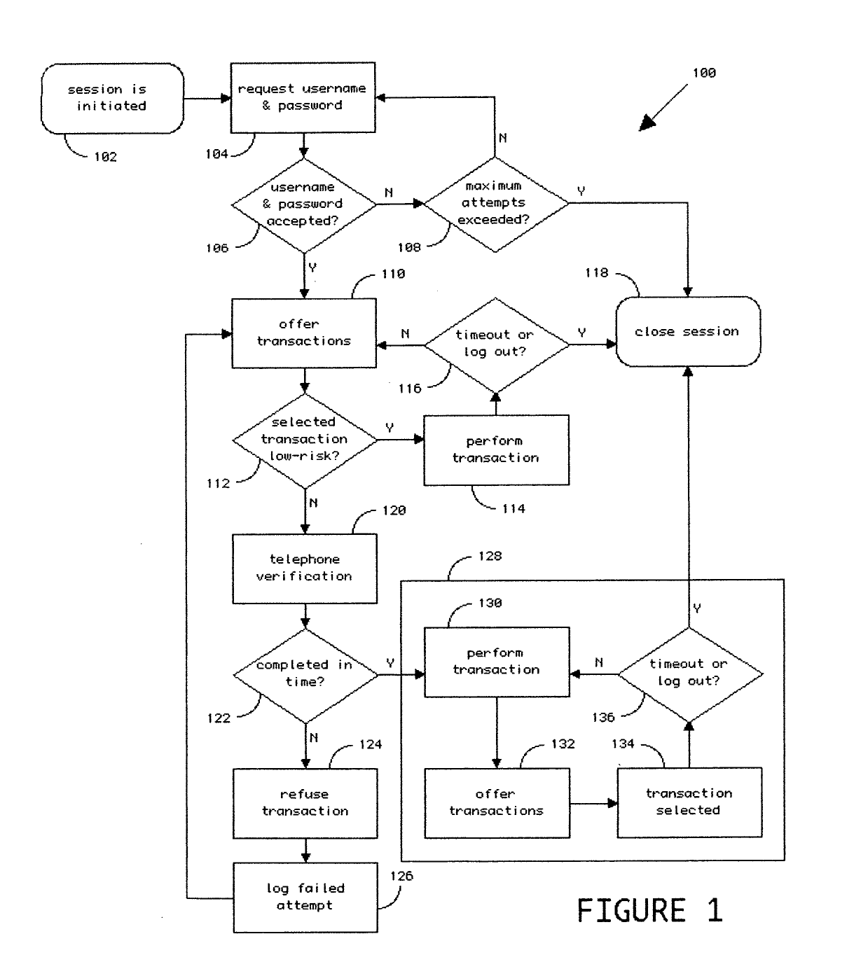

Referring first to FIG. 1, a transaction session 100 is initiated in step 102. A well-known, prior art authentication process is performed in step 104. FIG. 1 depicts a remote transaction process of the present invention, which may be implemented as either an IVR or an online process. The IVR implementation will be apparent to those skilled in the art, given the discussion that follows, which presumes an online banking scenario for illustration purposes. The discussion below concerning use of the invention in an online session is not to be considered a limitation, but merely a suitable example for teaching the use and advantages of the present invention.

In the case of online banking, the bank customer initiates an online session in step 102 by signing onto the bank's secure website. The customer inputs the username and password as login credentials in order to login in step 104. The bank server accepts or denies that login in step 106. If the login is unsuccessful, in step 108 a check is made that the customer has not exceeded a policy-based limit on the number of attempts. If so, the session is closed in step 110. If not, an additional attempt is allowed by returning to login step 104. Well-known in the art is the introduction of a delay, preferably in policy driven step 108, so that automated attempts to guess a customers password are significantly slowed, giving other detection systems (not shown) or warnings to human supervisors adequate time to react to a detected hacking attempt.

If a proper username and password combination is detected by step 106, then a selection of transactions is offered to the customer in step 110. If the selection made by the customer in step 110 is determined in step 112 to comprise low-risk or ordinary activities, as defined by bank policy, then process of the transaction proceeds in step 114. Examples of low-risk activities may include checking an account balance, or completing a monthly bill payment to a pre-established payee.

For simplicity in this diagram and those that follow, the situation where a customer has become disconnected from the system, or otherwise has left the session inactive for a pre-determined period of time, the resulting timeout is treated as if it were a selected transaction. Also, an explicit choice by the customer to logout of the session is itself treated as a transaction. While an actual implementation may not treat logouts or timeouts in this fashion, it is convenient for the description here, and merely represents a preferred embodiment.

In continuation check step 116, if the transaction is a timeout or a logout, the session is closed at step 110. Otherwise, the session continues by repeating the offer of available transactions in step 110.

In step 112, if the transactions selected in step 110 represent any higher-risk or unusual activities, as defined by bank policy and perhaps by the customers historical behaviors, then the telephone verification step 120 is required, thereby engaging a “what you have” leg of the security triangle. Examples of higher-risk banking transactions may include moving or sending funds, adding a payee, and changing customer and account profile information, and changing passwords.

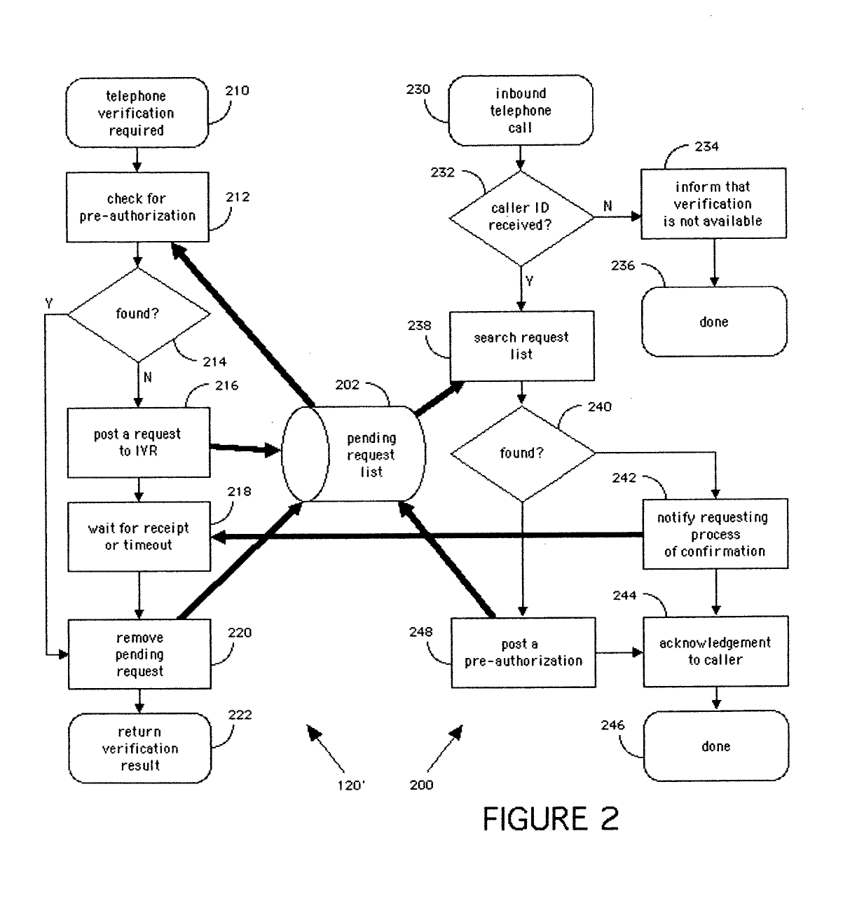

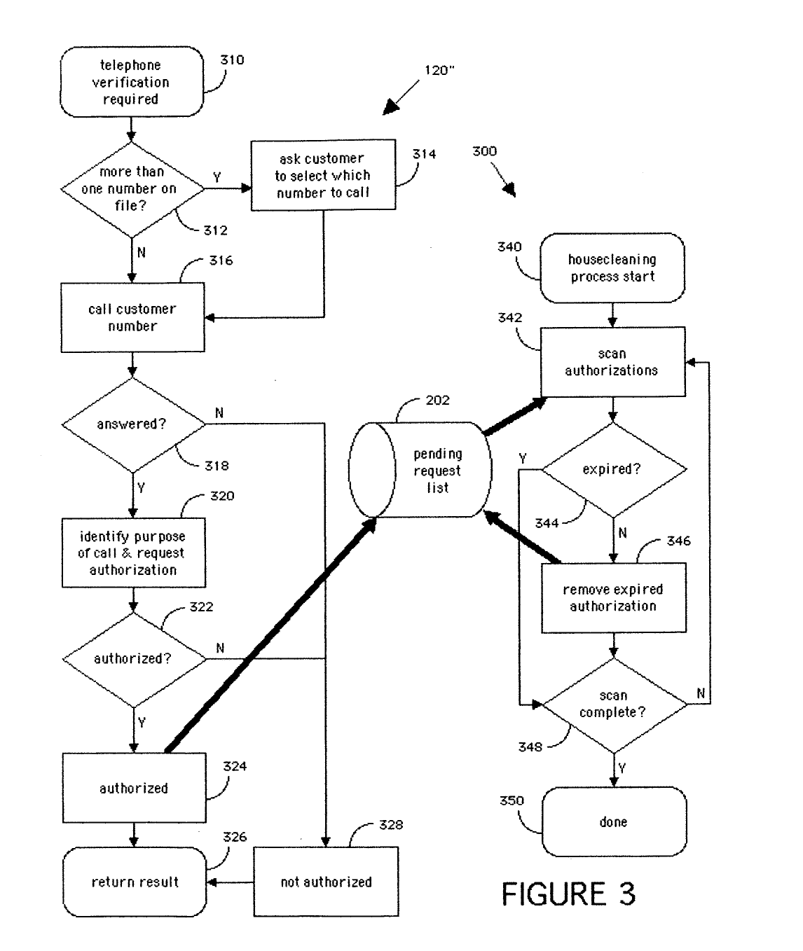

Different embodiments of telephone verification step 120 are discussed in greater detail in conjunction with FIG. 2 and FIG. 3. However, regardless of the embodiment of telephone verification step 120, a verification result is returned.

When telephone verification step 120 is completed, a check is made that the result was both successful, and that it occurred within a time limit defined by the bank's policies in step 122. The bank customer might have some choices in this instance, but only choices that fall within the security demands of the banking system.

If the required timing between the online session and telephone verification is not met, or the verification otherwise failed, then the transaction is refused in step 124 and the customer is informed that the attempt was unsuccessful in step 126, at which point the session preferably returns to step 110 to allow further, low-risk transactions, or to selected and retry verification for a higher-risk transaction. A similar limitation to that provided by step 108 may be employed in this loop as well (not shown).

If the telephone verification step 120 is found in step 122 to have been completed successfully and meets the time requirement is met, then the session enters a high-security mode 128.

As a result, the higher-risk transaction selected in step 110 is finally performed in step 130. Subsequent transactions are offered in step 132, which may include additional higher-risk transactions not previously offered in step 110. The customer can select from among these transactions in step 134. Timeouts and a selection to logout are detected in step 136, and as before either will result in a termination of the session at step 110. Otherwise, the selected transactions are performed in step 130, and so the session can continue in high-security mode 128 until concluded.

Referring to FIG. 2, the preferred embodiment of the telephone verification step 120 is shown as telephone verification process 120′, as is its relationship to call-in process 200.

In FIG. 2, and also in FIG. 3, the heavy arrows represent data flows to and from the database comprising pending request list 202.

Telephone verification process 120′ begins with a notification that telephone verification is required in step 210. The customer is notified that a call should be placed to a pre-determined call-in telephone number, and that the customer must use one of the telephones previously registered to place this call.

If none of the required phones is available, or for any other reason, and at any time in process 120′, the customer can abort the telephone verification process 120′, and immediately jump to and execute step 222 to return with the status that verification was unsuccessful.

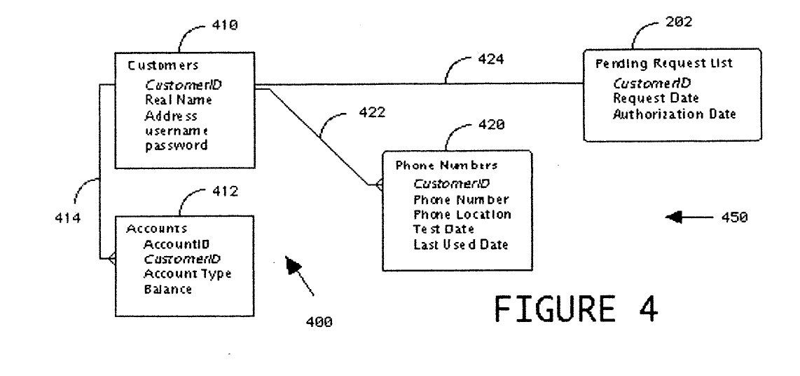

The verification process 120′ preferably checks a database (described in more detail below in conjunction with FIG. 4) containing pending request list 202. This check for pre-authorization 212 examines pending request list 202 to determine whether a pre-authorization has been noted for the customer of session 100.

Alternatively, pre-authorization check 212 can search pending request list 202 for a pre-authorization noted for the account associated with session 100.

If a pre-authorization is detected by step 214, then processing continues at step 220, where a detected authorization is removed, or marked as used (discussed further in conjunction with FIG. 4), and a successful verification result is returned in step 222.

If in step 214 no pre-authorization was found, a request for authorization is posted to pending request list 202 in step 216, at which point telephone verification process 120′ will wait in step 218 for either a verification to be received, or for a time limit specified as a matter of policy to expire.

Preferably, the posting step 216 provides an identification of session 100, or other mechanism (not shown) to facilitate notification of the execution of telephone verification 120′ so that the process waiting in step 218 can be efficiently and timely notified that an authorization has been received. Many suitable mechanisms for inter-process communication and providing a blocking of execution until another process completes or a timeout occurs will be familiar to those skilled in the art.

When either notification that an authorization has been received, or a timeout has lapsed, processing continues past step 218. In step 220, the pending request is either removed, or marked as expired, or marked as satisfied (discussed further with respect to FIG. 4).

If a timeout ended the wait in step 218, then an unsuccessful result is returned in step 222. However, if an authorization was successfully received and detected, a successful result is returned in step 222.

Call-in process 200 is initiated when an inbound telephone call is detected in step 230.

If the inbound call is not tagged with caller ID information, well known in the art, either because the caller ID is blocked or because it is not supported by some portion of the telephone connection being used, then its absence is detected in step 232 and in step 234 the call-in process informs the customer that the caller ID could not be detected and recommends that an alternate telephone verification process should be used. A customer might use this recommendation to select a call-out process as a preferred method for telephone verification in a future iteration of step 110, or a call-out process might be selected if telephone verification process 120′ times out.

If caller ID is detected in step 232, then call-in process 200 searches pending request list 202 for sessions having a customer or account related to the detected caller ID (a query appropriate to this search is discussed below with respect to FIG. 4).

If such a pending request is not found in list 202, then step 240 directs process 200 to post a pre-authorization derived from the caller ID in step 248.

However, if at step 240 a pending request is found, then process 200 proceeds in step 242 to notify the corresponding process waiting at step 218. Various mechanisms for inter-process communication of this sort will be apparent to those skilled in the art.

Once the authorization has been posted as a pre-authorization in step 248, or a pending verification process waiting at 218 has been notified by the call-in process 200 at step 242, then the customer is preferably notified by the IVR system providing telephone access and implementing call-in process 200. This notification occurs in step 244, and reports the successful outcome. At this point, the call-in process 200 completes in step 246 and the call terminates.

In an alternative version of the call-in process, a more elaborate script can be employed by the IVR. The pending request list 202 may detect that the caller ID received in step 232 may be related to more than one customer, or more than one account. In such a case, it may be desirable to select which one of the associated customers or accounts is intended. Such a selection may be plainly made by direct selection by the customer calling in, or the selection may be made by the customer inputting a PIN number or other passcode. Other means of discriminating between customers sharing a registered telephone number include biometric techniques, such as a voice print. Alternatively, each customer sharing a particular registered telephone can be given a distinct dial-in phone number to be used. In step 232, in addition to the caller ID value presented, the IVR system can make use of the dialed-number information, well known in the art, which reports to the IVR system what number the customer had called. In this manner, a single IVR system can be responsive to a caller dialing any of a number of telephone numbers, and can make use of that dialed telephone number in the query used in step 238. For this alternative implementation, each customer sharing a registered telephone can be assigned a different dial-in number, so that the paring of a registered telephone number and a specific dial-in number corresponds to exactly one customer (or one account). While this assigned dial-in number is not included in the database shown in FIG. 4, and discussed below, extension of that schema does not exceed ordinary skill in the art.

In step 248, the IVR may also query the customer for a time-frame for which the preauthorization should be valid. In this way, the customer can schedule a login for some preset time frame in the future and that time frame would be recorded in pending request list 202.

Those skilled in the art will recognize the potential for deadlocks to occur between processes 120′ and 200, and will take the appropriate, well-known precautions to mitigate these.

While this discussion is directed at an online session, and presentation of such options is well known in the art using a web browser as an interface, this same process can be executed using an IVR system. If the IVR session was initiated from a registered telephone and caller ID was available, then call-in process 200 will have completed and pre-authorized the session 100. If caller ID is not available, and the session was initiated from a registered phone, then call-out telephone verification process 120′ discussed is used instead. Even if the telephone number used in the call-out 120′ described below is for the telephone currently in use for session 100, the verification 120′ can be accepted by switching between calls with a call-waiting feature common on most telephone services, and then back to session 100.

Referring now to FIG. 3, call-out process 120″, is shown. Call-out process 120″ may be selected as an implementation of telephone verification process 120 as a matter of the institution's policy, or as a matter of the customer's preference, or as a matter of necessity when, at a particular moment, a customer's registered telephone number cannot successfully connect with call-in process 200 because the caller ID is not being detected in step 232.

Call-out process 120″ is activated from telephone verification step 120, and begins at step 310. In step 310, notification is given to the customer that it is necessary for the institution to call the customer's registered telephone number and receive a verification in order for the requested transaction to proceed.

Note that at any time throughout call-out process 120″ that the customer desires, the call-out process can be aborted, in which case execution of the process jumps (not shown) to step 328, after which the process returns in step 326 with an unsuccessful result.

If call-out process 120″ detects in step 312 that the customer has more than one telephone number registered, then in step 314 the customer is asked which number should be used. Preferably, rather than disclosing the specific telephone numbers that might be used, the system would instead refer to the telephone numbers by their location, for instance, “home”, “work”, or “mobile”. Once selected in step 314, or immediately if there was only one telephone number registered, process 120″ initiates a telephone call to the customer's number in step 316.

The IVR executing process 120″ must detect that the telephone is answered before it can proceed. If no answer is detected, the process aborts to step 328 as previously discussed.

If an answer is detected in step 318, the IVR preferably identifies itself and the basis of the call in step 320. This includes asking for authorization of the session, or of the specific transaction, pending.

The authorization may be given or denied using touch-tone responses, voice responses (which require the IVR to have voice recognition capabilities), and optionally biometric voice identification capabilities suitable for actually identifying the customer by voice. Which mode of authorization is requested or considered sufficient can be dynamically chosen as a matter of policy based on the nature of the transaction (e.g., voice identification might be required for transactions over a certain amount), or may be selected as a matter of which outbound call equipment was used.

Regardless of the mode of authorization, the results are evaluated in step 322. If the authorization was denied, then process 120″ aborts to step 328, as above.

If the authorization is granted, then in step 324 the pending request in pending request list 202 is deleted, or marked as satisfied, as a matter of policy. Then the call-out process 120″, returns with a success status in step 326.

FIG. 3 also shows a housecleaning process 300 which is periodically executed according to policy. It is the purpose of the housecleaning process to remove inactive or expired records from pending request list 202. Again, depending on policy, records so removed from the database may be archived, if needed as financial records or to provide a forensic trail.

Housecleaning process 300 is triggered periodically at step 340. This may be once a month, once a day, or every few minutes, depending on the policies established by the institution.

The pending request list 202 is searched in step 342. Each record identified in step 344 as being expired is removed in step 346. Records that are not expired are left alone.

The housecleaning process loops at step 348 until the scan is complete. Once done, the process terminates at step 350 and is ready to be retriggered per policy, as mentioned above.

FIG. 4 is a schema for an enhanced database 450 of the present invention built upon traditional banking database 400.

Traditional banking database 400 comprises customer table 410, account table 420, and customer-account relationship 414. Each account in table 412 is associated with exactly one customer 410, though each customer might have more than one account.

Those skilled in the art will recognize that actual banking databases are considerably more complex than as shown by traditional database 400, but the simplification herein is intended for clarity. In particular, not shown are any tables related to transactions, nor any journaling or indexes. Further, as an example, the customer table 410 unlikely to be considered by those skill in the art as normalized, nor complete. Nevertheless, the simplified database as shown is sufficient to teach the principles by which a database may be built or adapted to employ the present invention.

As illustrated in FIG. 4, customer records in customer table 410 include fields for CustomerID, the table key, the customer's name (shown as ‘Real Name’ to be distinguished from the username), the customer's Address, and the login information for distance transactions: a username and password. Note that username might be substituted by an account number or perhaps the customer's social security number, as this would allow entry of the username with a telephone touchpad for use when initiating telephone-based transactions, for instance with an IVR system. Also included is a password field, which is preferably a combination of upper and lower case alphabetic characters, numerals, and punctuation marks, (i.e., a strong password), but which may be as simple as a personal identification number (PIN) suitable for access using a telephone or ATM touchpad.

In an alternative embodiment, fields such as username and password might be removed to a separate table (not shown) which retains a relationship, either direct or indirect, to customer records in table 410. This would allow separate username/password combinations to be used when initiating IVR and online sessions.

The simplified account table 412 illustrates fields for a unique AccountID, the CustomerID of the account owner, an Account Type (for example “checking”, “savings”, “mortgage”, etc.), and the current account Balance.

While the simplified illustration of the accounts table 412, customer table 410, and customer-account relationship 414 do not support, for example, a single account having multiple owners, such databases do exist, and modifications to this schema are well within the ordinary skill in the art.

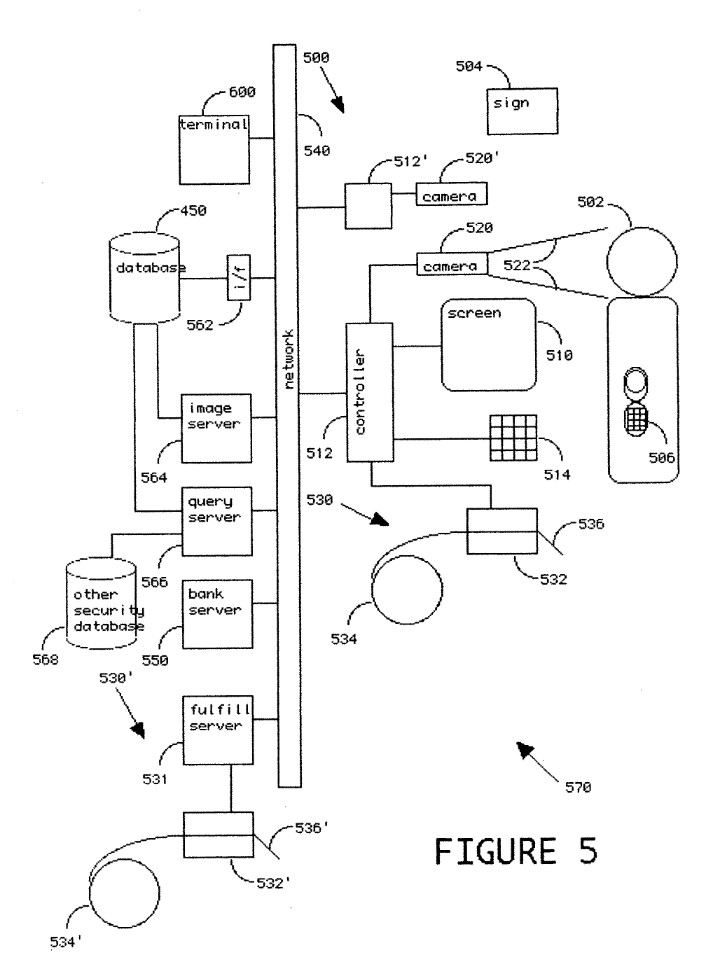

By an enrollment process, one embodiment of which is discussed in conjunction with FIG. 5, and elsewhere herein, a customer causes one or more telephone numbers to be associated with his records. In the alternative, such a phone number can be collected at the time a customer record is created. Phone number table 420 is provided to store each such telephone number.

Phone number table 420 includes a field for storing a Phone Number. Preferably a Phone Location field is provided for identifying the type of location of the Phone Number, for example, “home”, “work”, “mobile”, etc. so that in later transactions a customer may direct the system to “call my home phone” without the actual phone number being exchanged in the transaction. Preferably, the record for a phone number would include fields for a test date and last used date. These fields would log the date and time when the Phone Number was first successfully contacted, thereby becoming validated, and the date of the most recent contact with that phone number, a date suggestive of the currentness of the Phone Number data.

In the alternative, the phone location field may accept a free-form entry from the customer, such as “Mom's house”. In another alternative embodiment, Phone Number table 420 may also include a field (not shown) to uniquely identify each record.

In the preferred embodiment, customer-telephone relationship 422 ensures that each Phone Number entry in 420 is associated with a customer record in customer table 410.

Note that the Phone Number field is not required to be unique in Phone Number table 420. This allows for several customers, for instance a husband and wife, to each have separate customer records and accounts, but to each register their shared home telephone number for use in telephone verification step 120.

In an alternative embodiment, Phone Number table 420 could instead have a direct relationship (not shown) with a particular account record in account table 412. In this case, Phone Number table 420 would have field AccountID instead of CustomerID as a foreign key.

Pending request list 202 is preferably implemented as a table within enhanced database 450. While in the preferred implementation the illustrated pending request list 202 is linked by customer-pending-request relationship 424, those skilled in the art will recognize that similar functionality could be obtained by providing alternative relationships to Phone Number records in table 420, or account records in table 412, without straying from the spirit of the present invention.

The pending request list 202 preferably includes separate fields for recording the Request Date and time, and Authorization Date and time.

In the case where a session-in-progress performs telephone verification step 120, pending request list 202 may be searched in pre-authorization check step 212 for a record having the appropriate CustomerID and a sufficiently recent Authorization Date and time (where the definition of “recent” is a predetermined maximum acceptable age defined as a matter of policy). If no such record is found, a new record is entered in request posting step 216 providing the current CustomerID and the current time as the Request Date.

When inbound call process 200 is activated, request search step 238 will search for pending request list 202 for a record having any customer related to the Phone Number by caller ID in step 232. For the schema shown in FIG. 4, this would represent a join between tables 202 and 420 on their respective CustomerID fields, where the Phone Number field of table 420 is equal to the caller ID. The result of this query will include all pending requests by customers having listed the phone number detected by caller ID. Of these, those records not having an Authorization Date already filled, are updated by setting the Authorization Date field to the current time in notification step 242. If no such record is found, a pre-authorization record is created in pending request list 202, by creating a record for each customerID associated with the phone number provided by caller ID with an Authorization Date specified by the current time.

In the alternative, as a matter of policy, pre-authorizations might be accepted for those customers who share a phone number with other customers.

In another alternative, pre-authorization step 248 might request a PIN or other identification (not shown) to distinguish among customers sharing a phone number.

Referring now to FIG. 5, wherein is shown a distance transaction system 570 of the present invention.

Database 450 is managed by a query server 566 having an interface to network 540. Database 450 may be directly accessed through network interface 562 by secure terminal 500 (typically, an ATM or an institution-provided kiosk). Remote transactions can be conducted by a customer 502 during sessions initiated through remote terminal 600 connected to network 540. A common implementation of remote terminal 600 is a PC running a web browser, especially if network 540 comprises the Internet. Banking server 550 is representative of the institution's server for conducting transactions, and may connect directly to database 450 through interface 562, or over network 540 through the query server 566. Query server may also attach to other databases 568, which might contain additional risk or fraud related data such as stolen cards, individuals whose account may have been compromised, lien data, law enforcement provided lists, etc.

Banking server 550 preferably has IVR capabilities providing telephone access so that inbound calls can be received and outbound calls placed, in accordance with the processes previously described. Alternatively, banking server 550 can access a separate IVR system (not shown) through network 540.

Secure terminal 500 is comprised of a controller 512, which is attached to display 510 (which may be a touchscreen), keypad and card reader 514, camera 520 having field-of-view 522. Alternatively, a separate security camera 520′ having camera controller 512′ is able to monitor the proximity of the secure terminal 500 and stream the video onto the network 540.

During a transaction at secure terminal 500, video from either camera 520 or 520′ may be sent to image processing server 564, which records images associated with each transaction into database 450 (the tables for records of transactions and these images were not shown in FIG. 4). Preferably, image processing server 564 is capable of face recognition, thereby providing a “who you are” element of security to transactions taking place at secure terminal 500.

Preferably signage 504 identifies secure terminal 500 as one supporting enrollment of telephones.

In the preferred embodiment, registering of a telephone can be initiated when customer 502 presents at secure terminal 500. Using an ID card (not shown), such as an ATM/debit card, the customer initiates a transaction by inserting the ID card into card reader 514 and entering the corresponding PIN into the keypad 514, in the manner well known.

One of the transaction options presented by controller 512 to customer 502 on display 510 is registering a telephone as a security token.

When selected, this option prompts controller 512 to query customer 502 for a telephone number. Customer 502 provides the telephone number for telephone 506, which may be a telephone number tied to a landline, but is preferably a mobile telephone number.

Controller 512 may also ask for a location designation for telephone 506, such as “home”, “work”, or “mobile”, as previously discussed.

Controller 512 transacts with query server 566, and enters the number of telephone 506. and preferably its location into table 420 of database 450 and associates that entry with the record in table 410 associated with customer 502.

Preferably, if telephone 506 is a mobile telephone, controller 512 initiates a telephone activation process (not separately shown), which is similar to dial-out process 120″. However, purpose identification step 320 explains that the telephone is being enrolled as a security token and asks the customer to verify the enrollment. A successful completion of the telephone activation process updates the corresponding record in table 420 by setting the Test Date field to the current time.

Alternatively, especially if telephone 506 is not a mobile telephone, controller 512 can request a time when it might be convenient to schedule the telephone activation process.

Still another alternative would be trigger a telephone activation process from remote terminal 600, at a time convenient to customer 502.

Note that it is likely not that controller 512 executes telephone activation process itself. Rather, controller 512 preferably requests banking server 550 to initiate the telephone activation process.

Another transaction that can be requested by customer 502 at secure terminal 500 is for a physical security token 536 to be issued to customer 502. Security token dispenser 530 comprises an inventory 534 of security tokens, and a mechanism 532 for issuing individual token 536. Mechanism 532 is one of a reader, writer, or counter of the individual tokens, such that before token 536 is dispensed, information identifying the token is read, or written, or if the tokens are in a known sequence, the count of the token being dispense will correspond to a pre-determined value for the token.

For instance, a token may be encoded with a certificate, the public portion of which can be read by reader 532.

Alternatively, the token may be attached to handling medium (e.g., a card) having a barcode and reader 532 reads the barcode, and controller 512 stores this reading in database 450 and later cross-referenced to obtain the certificate of the token.

In still another alternative, writer 532 can store a newly issued certificate onto token 536.

And in still another alternative, counter 532 returns an index into a list of predetermined certificates corresponding to those embedded in the tokens provided in inventory 534.

In an alternative embodiment, the issuance of a security token can be performed by remote token fulfillment center 530′, wherein remote token inventory 534′ is handled by mechanism and printer 532′ to dispense tokens 536′ having appropriate mailing information so that the newly dispensed tokens can be shipped directly to an address for customer 502 gleaned from database 450.

An example of a suitable security token 536 is a password number generator such as the RSA SecurID product manufactured by RSA Security, Inc. of Bedford, Mass.

Other similar transactions that preferably take place at secure terminal 500 would be those involving changes to records in phone number table 420, such as deletions, or edits to phone numbers, for instance, when a customer changes telephone numbers.

Alternatively, such change transactions to records in phone number table 420 might be carried out in remote session 100 and authorized with telephone verification 120 using a different phone number record.

As with all such systems, the particular features of the user interfaces and the performance of the processes, will depend on the architecture used to implement a system of the present invention, the operating system of the servers and controllers selected, the bandwidth and other properties of the network selected, and the software code written. It is not necessary to describe the details of such programming to permit a person of ordinary skill in the art to implement the processes described herein, and provide graphical or interactive voice response interfaces suitable for executing the scope of the present invention. The details of the software design and programming necessary to implement the principles of the present invention are readily understood from the description herein. Various additional modifications of the described embodiments of the invention specifically illustrated and described herein will be apparent to those skilled in the art, particularly in light of the teachings of this invention. It is intended that the invention cover all modifications and embodiments, which fall within the spirit and scope of the invention. Thus, while preferred embodiments of the present invention have been disclosed, it will be appreciated that it is not limited thereto but may be otherwise embodied within the scope of the claims.

I claim:

1. A method for performing a first transaction on a first account with verification that said first transaction is requested by a customer, said method comprising the steps of:
a) providing a database to track associations among said customer, said first account, and at least one phone number, said database further having login credentials for said customer;
b) providing a server, said server having access to said database, said server further having a first telephone access;
c) providing a terminal, said terminal having communication with said server, said terminal further being accessible to said customer;
d) verifying that a first session occurs through said first telephone access and a first one of said at least one phone number;
e) initiating a second session between said server and said customer through said terminal, wherein said customer provides said login credentials
f) selecting said first transaction during said session; and,
g) performing said first transaction on said first account after step d).

2. The method of claim 1, further comprising the step of:
h) obtaining in said first session a confirmation of the validity of said second session.

3. The method of claim 1, further comprising the step of:
h) obtaining in said first session a confirmation of said first transaction.

4. The method of claim 1, wherein said server further comprises a second telephone access, said second telephone access having IVR capabilities, and wherein said terminal comprises a telephone, said terminal having communication with said server through said second telephone access.

5. The method of claim 4, wherein said second session is telephone banking.

6. The method of claim 1, wherein said server has communication with said server through a network.

7. The method of claim 6, wherein said network is the Internet.

8. The method of claim 7, wherein said second session is online banking.

9. The method of claim 1, wherein, in said second session, said first account is selected by said customer from a plurality of accounts associated with said customer in said database.

10. The method of claim 1, further comprising the steps of:
h) selecting a second transaction during said second session; and,
i) performing said second transaction on said first account without waiting for step d).

11. The method of claim 1, wherein step d) is performed by said server receiving an inbound call placed to said first telephone access, said inbound call having a caller ID of said first one of said at least one phone number.

12. The method of claim 1, wherein step d) is performed by said server completing an outbound call from said first telephone access to said first one of at least said one phone number.

13. The method of claim 1, wherein said at least one phone number is a plurality of phone numbers, and said first one of said at least one phone number is selected by said customer during said second session.

14. The method of claim 1, wherein step d) is performed before step g).

15. The method of claim 1, wherein step d) is performed before step e).

16. The method of claim 1, wherein said first telephone access has IVR capabilities and step d) further comprises an interaction with said customer using the IVR capabilities.

17. The method of claim 1, further comprising the steps of:
h) providing an ATM in communication with said database; and,
i) inserting said first one of said at least one phone number into said database so as to be associated with said customer, said inserting being performed by said customer using said ATM.

18. A method for performing a transaction on an account with verification that said transaction is requested by a customer, said method comprising the steps of:
a) providing a database to track associations among said customer, said account, and at least one phone number, said database further having login credentials for said customer;
b) providing a server, said server having access to said database, said server further having a telephone access, said telephone access having IVR capabilities;
c) verifying that a session occurs through said telephone access and a telephone having said first one of said at least one phone number;
d) initiating said session between said server and said customer using said telephone, wherein said customer provides said login credentials
e) selecting said transaction during said session; and,
f) performing said transaction on said first account after step c).

19. A system for performing a transaction on an account with verification that said transaction is requested by a customer, said system comprising:
a database, said database having a customer record associated with said customer, an account record associated with said account, a telephone number record for a telephone, said customer having access to said telephone, said database able to associate said customer record with said account record and said telephone number record;
a server, said server having communication with said database, said server further having IVR capabilities; and,
a terminal, said terminal having communication with said server, said customer having access to said terminal; and
wherein a request for a transaction is made by said customer through said terminal to said server, said server in response to said request requiring verification between said IVR capabilities and said telephone before said transaction is performed.

20. The system of claim 19, wherein said terminal communicates with said server via the Internet.
